(19) United States
(12) Patent Application Publication
(10) Pub. No.: US 2007/0217191 A1
(43) Pub. Date: Sep. 20, 2007

(54) Ornamental lamp

(76) Inventor: George Tsai, Taipei (TW)

Correspondence Address: BIRCH STEWART KOLASCH & BIRCH, PO BOX 747, FALLS CHURCH, VA, 22040-0747, US

(21) Appl. No.: 11/375,102

(22) Filed: Mar. 15, 2006

(51) Int. Cl. F21V 1/00; F21V 11/00

(52) U.S. Cl. 362/237; 362/252; 362/806; 362/311

(57) ABSTRACT

An ornamental lamp has at least one translucent shell, and at least one lamp apparatus. At least one translucent shell is translucent and can be shaped or stacked on each other to form figures. The lamp apparatus is mounted in the translucent shell. The lamp apparatuses highlight the translucent shell to enhance the 3D visual effect and to create an ice-block visual effect.

### BACKGROUND OF THE INVENTION

1. Field of Invention

The present invention relates to an ornamental lamp, and more particularly to a decoration with a translucent shell with one or more lamps.

2. Description of the Related Art

People use ornaments to improve the ambiance of festivals and holidays, but conventional ornaments are not conspicuous enough to attract people. So people usually mount lamps or strings of lights inside or outside the ornaments to make the ornament shine. The ornaments are normally placed at entrances to houses, restaurants and exhibitions to decorate the environment.

A conventional ornament in accordance with the prior art has a body and at least one lamp. The body can be any shape, such as a Christmas tree, a snowman and the like, and the at least one lamp is mounted on or in the body to illuminate the ornament. Because the body is a solid substance and is too heavy to be moved, people mold ornaments from plastic or other light material and mount the at least one lamp on or in the hollow, molded ornaments. These molded ornaments have a volume and are light and easy to move. However, molded ornaments have a number of shortcomings. First, molded ornaments are not easy to take apart to decrease the volume for storage. Second, the at least one lamp is generally mounted outside the ornament, which does not improve the beauty of the whole ornament or emphasize the 3-D visual effect of the ornament and also does not create the ice-like or snow-like visual effect to make the ornament look like real snowman especially in Christmas.

To overcome the shortcomings, the present invention provides an ornamental lamp to mitigate or obviate the aforementioned.

### SUMMARY OF THE INVENTION

The primary objective of the present invention is to provide an ornamental lamp that can be disassembled for storage and reassembled conveniently and easily and a shell in which the at least one lamp can be mounted to enhance the 3-D visual effect of the ornament and look vividly like real ice or snow.

To achieve the objective, the ornamental lamp has at least one translucent shell, and at least one lamp apparatus. At least one translucent shell is translucent and can be shaped or stacked on each other to form figures. The lamp apparatus is mounted in the translucent shell. The lamp apparatuses highlight the translucent shell to enhance the 3D and the ice-like or snow-like visual effect.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of an ornamental lamp in accordance with the present invention;

FIG. 2 is a partially exploded perspective view of the ornamental lamp in FIG. 1;

FIG. 3 is an enlarged cross-sectional rear view of a joint between two shells of the ornamental lamp in FIG. 1;

FIG. 4 is an enlarged cross-sectional rear view of a joint between two shells in a second embodiment of an ornamental lamp in accordance with the present invention;

FIG. 5 is an enlarged cross sectional rear view of a top shell of the ornamental lamp in FIG. 1;

FIG. 6 is an enlarged cross-sectional side view of the top shell in FIG. 5;

FIG. 7 is a front view of a first configuration of an ornamental lamp in accordance with the present invention;

FIG. 8 is a front view of a second configuration of the ornamental lamp in accordance with the present invention;

FIG. 9 is a front view of a third configuration of the ornamental lamp in accordance with the present invention; and

FIG. 10 is a front view of a fourth configuration of the ornamental lamp in accordance with the present invention.

### DETAILED DESCRIPTION OF THE INVENTION

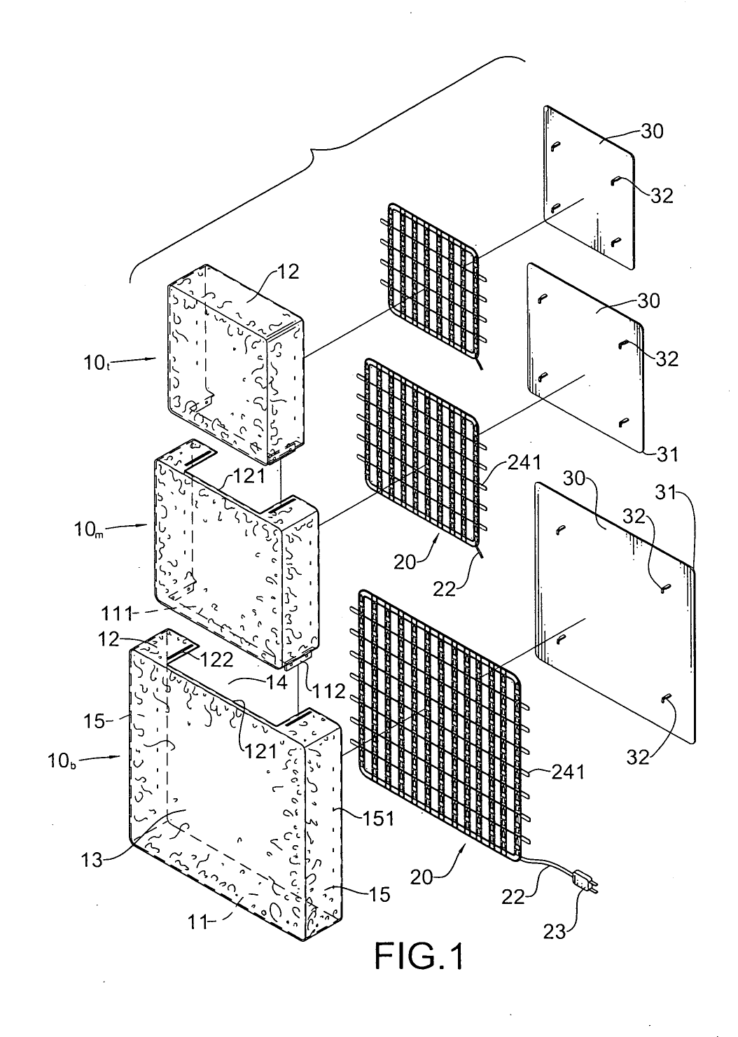

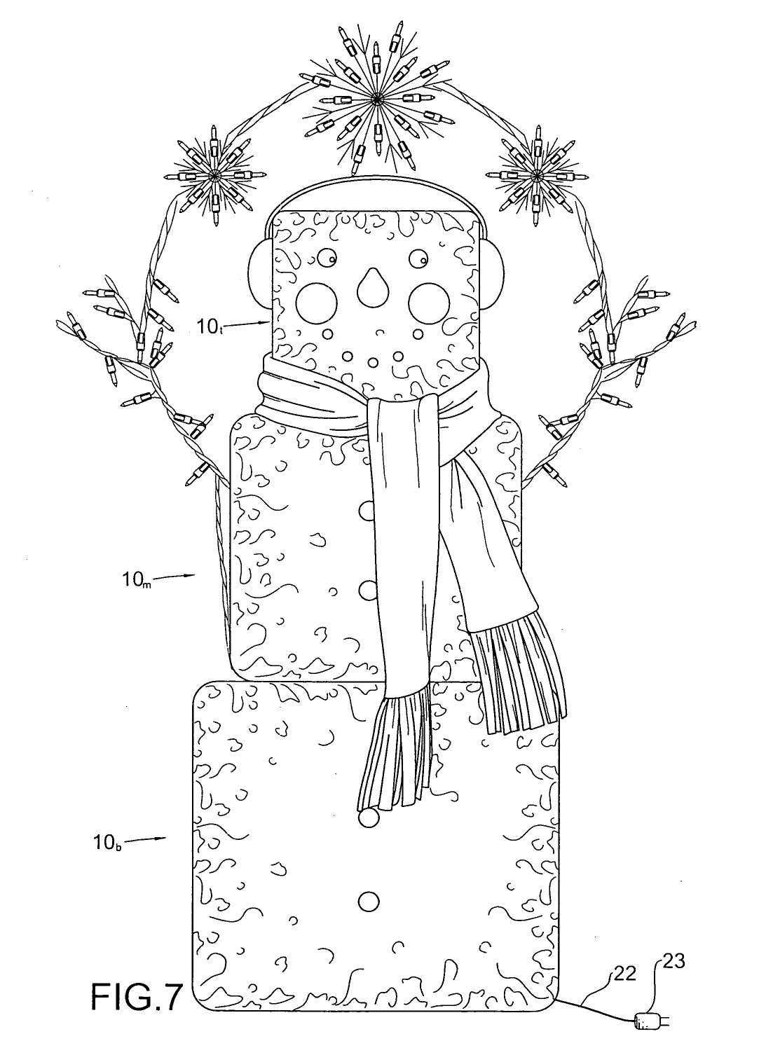

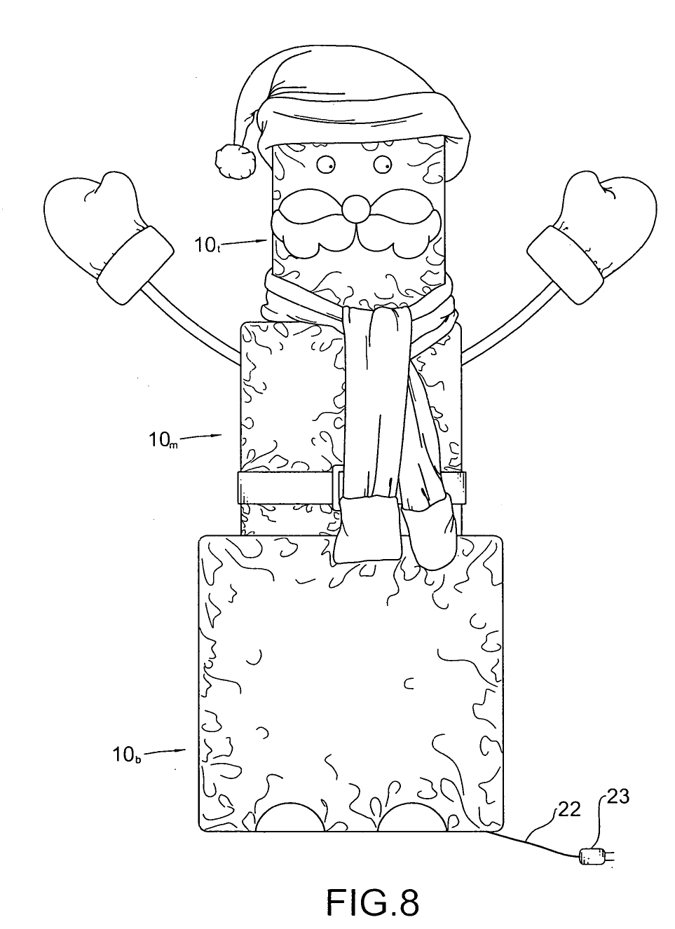

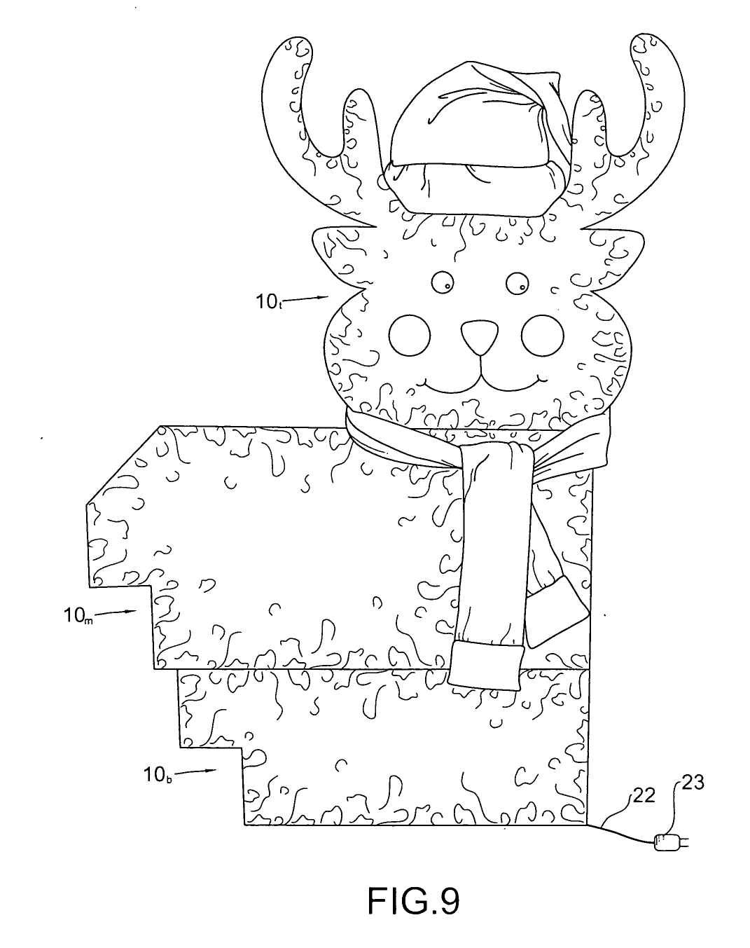

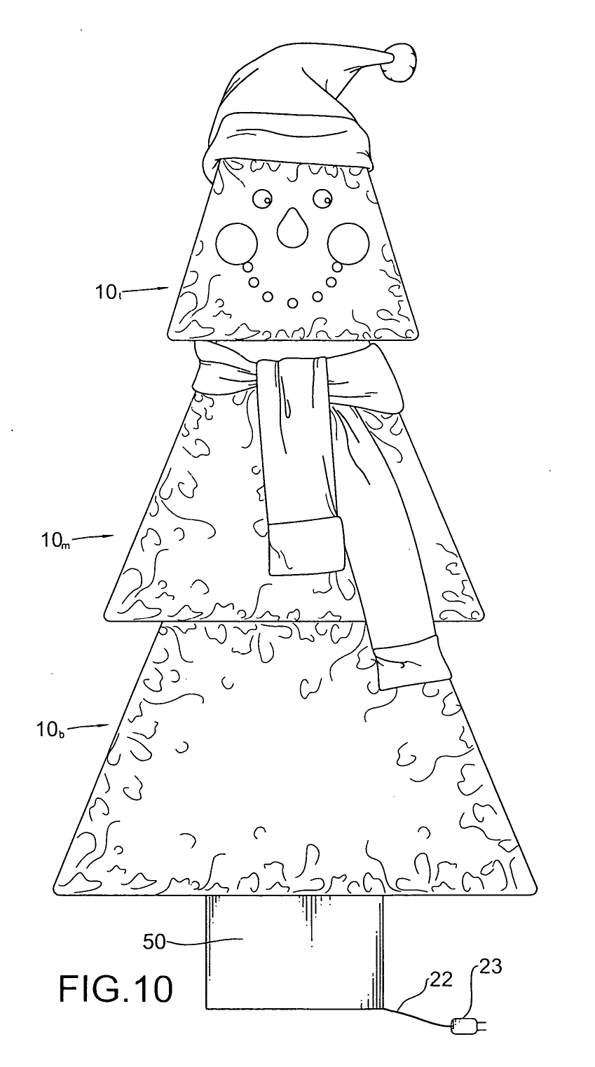

With reference to FIGS. 1, 7, 8, 9 and 10, an ornamental lamp in accordance with the present invention comprises an optional base (50), at least one translucent shell (10), at least one lamp apparatus (20), at least one optional cover (30) and optional accessories.

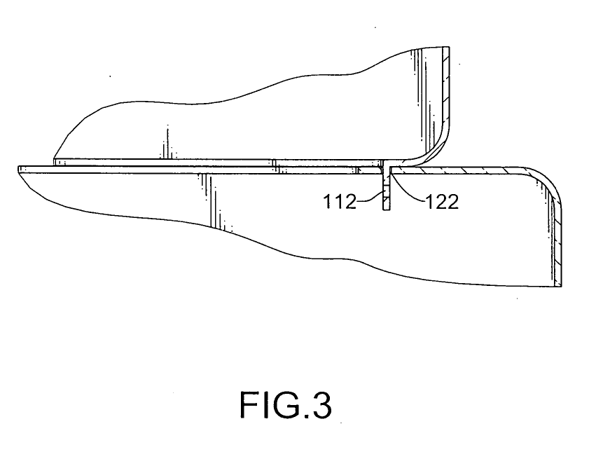

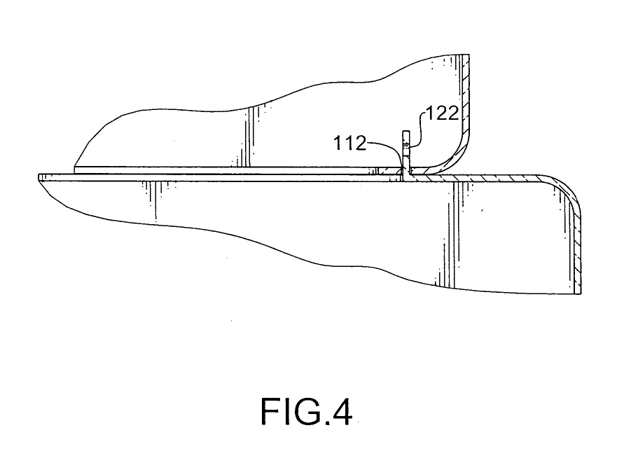

The base (50) has a bottom and a top. The bottom is flat so the base (50) can stand on a floor, sidewalk or any flat surface. With further reference to FIGS. 3 and 4, the top is also flat and may have an optional lower connector or an optional through hole. The lower connector may be one or more slots, recesses, blades or the like.

The at least one translucent shell (10) is polyhedral, may be square, trapezoidal or a shape to form a figure, may have different colors and patterns, comprises a bottom shell (10_{b}) and may further comprise one or more middle shells (10ₘ) and a top shell (10ₜ). Each translucent shell (10) has a front surface (13), an open rear (14), a top (12), a bottom (11), two sides (15) and a first connector. The figure may be part of a snowman, deer, Christmas tree or the like. The patterns may represent eyes, cheeks, leaves and other features on the figure. The bottom shell (10_{b}), one or more middle shells (10ₘ) and top shell (10ₜ) form appropriate parts of the figure and are stacked on each other.

The front surface (13) is translucent and may have relief.

The top (12) may be translucent and flat so another translucent shell can stand on the top and may have an optional lower connector (122) or an optional cutout (121). The lower connector (122) may be one or more slots, through holes, blades, protruding rods or the like. The cutout (121) is formed in the top (12) and communicates with the open rear (14).

The bottom (11) may be translucent and also flat so the translucent shell (10) can stand on any flat surface including the top of the base (50) or another translucent shell (10) and may has an optional upper connector (112) and an optional cutout (111). The upper connector (112) corresponds to, aligns with and connects to the lower connector on the base (50) or the lower connector (122) on an adjacent translucent shell (10). The cutout (111) is formed in the bottom (11), communicates with the open rear (14) and corresponds to and aligns with the through hole in the top of the base (50) or the cutout (121) in the top (12) of an adjacent translucent shell (10).

The sides (15) are translucent and may have relief, are formed and communicate with the top (12), the bottom (11) and the front surface (13) and each side has an inner surface and a rear edge.

The first connector may be multiple lamp frame connectors (151). The lamp frame connectors (151) are formed in a longitudinal line in the inner surfaces of the sides (15) near the rear edges and may be detents, grooves, slots, through holes or the like.

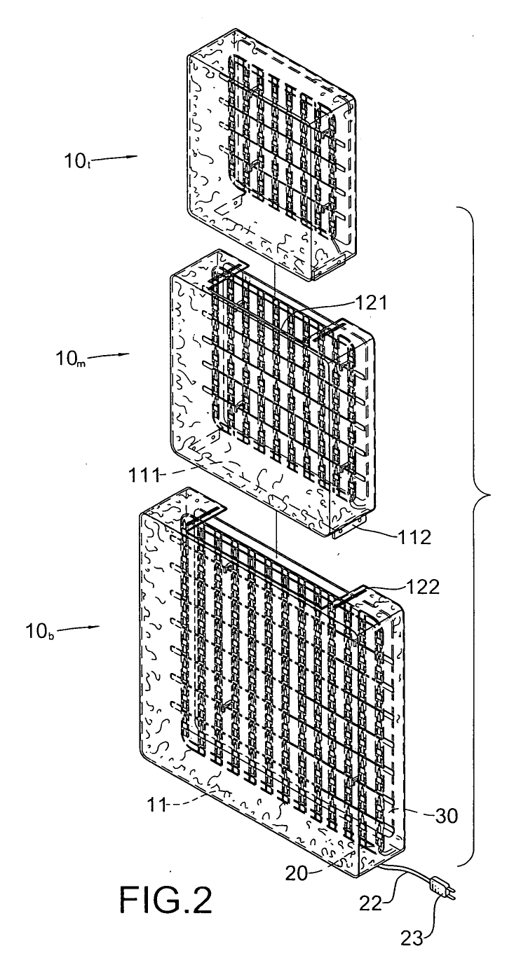

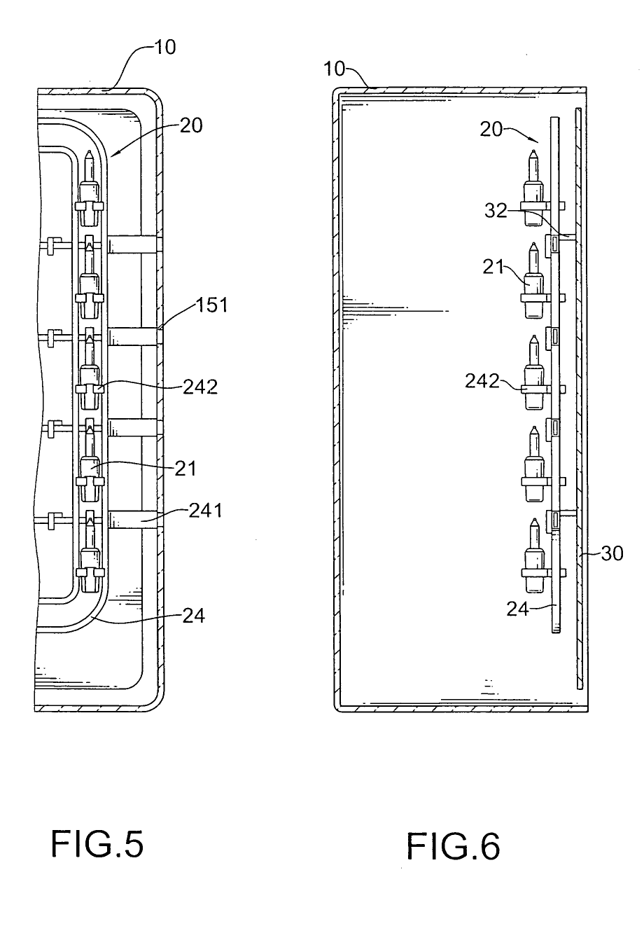

With further reference to FIGS. 2, 5 and 6, the at least one lamp apparatus (20) is mounted in the translucent shells (10). Each of the at least one lamp apparatus (20) has at least one lamp and a second connector. The at least one lamp apparatus has electric wires (22) and a plug (23).

The at least one lamp (21) are mounted respectively in the at least one lamp brackets (242), highlight the relief in the front surface (13) and the sides (15) of the translucent shell (10), enhance the 3D visual effect. The at least one lamp (21) may be at least one lamp frame (24) mounted inside the translucent shell (10), has two sides, a front, a rear, and at least one lamp bracket (242) and may be a grid-like frame.

The second connector mounted on the lamp frame (24) connecting to the first connector to combine the translucent shell (10) and the lamp apparatus (20). The second connector is multiple mounting tabs (241) when each of the at least one lamp (21) is a lamp frame (24). The mounting tabs (241) are formed on and protrude out from the sides of the lamp frame (24) and correspond to and are mounted respectively in the lamp frame connectors (151) inside the translucent shell (10). The at least one lamp bracket (242) is mounted on and protrudes from the front of the lamp frame (24).

The electric wires (22) electrically connect the lamps (21) in series or in parallel and may extend through the cutouts (111, 121) and the through hole in the base (50).

The plug (23) is connected to the electric wires (22) and selectively to an external power source to provide electricity to illuminate the lamps (21).

The cover (30) is attached to the lamp apparatus (20) inside the translucent shell (10) to close the open rear (14) of the translucent shell (10) and protect the lamp apparatus (20) and has an inside surface, four comers (31) and multiple connectors (32). The connectors (32) connect the cover (30) to the lamp frame (24) and may be implemented as four hooks mounted on and protruding from the inside surface of the cover (30) respectively near the four comers (31). The hooks hook onto the rear of the lamp frame (24).

Accessories like stick arms, scarves, gloves, hats, Christmas tree ornaments, sleigh bells and the like are mounted on the translucent shells (10) to make the ornamental lamp more interesting.

The ornamental lamp as described has numerous advantages. Because the ornamental lamp can be separated into many parts, storing, carrying and assembling the ornamental lamp is convenient and easy. Because the translucent surface (13) in relief of the translucent shell (10) refracts light, the 3-D visual effect is enhanced. If the at least one translucent shell of the ornamental lamp is white or mostly white, that will make the ornamental lamp look as covering a layer of snow and make the ornamental lamp look like a real snowman.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. An ornamental lamp comprising:
at least one translucent shell being polyhedral, and each one of the at least one translucent shell having
a front surface being translucent;
an open rear; and
a first connector; and
at least one lamp apparatus being mounted in the translucent shell and each of the at least one lamp having
at least one lamp mounted in the open rear of the translucent shell; and
a second connector connecting to the first connector to connect the at least on translucent shell and the at least one lamp apparatus.

2. The ornamental lamp as claimed in claim 1 further comprises a base having
a bottom being flat; and
a top being flat on which the at least one translucent shell stand.

3. The ornamental lamp as claimed in claim 1 further comprises at least one cover attached to the at least one lamp apparatus inside the at least one translucent shell to close the open rear of the at least one translucent shell and protect the at least one lamp apparatus and each one of the at least one cover having
an inside surface;
four corners; and
multiple connectors connecting the cover to the lamp frame of a corresponding lamp apparatus.

4. The ornamental lamp as claimed in claim 1, wherein
the at least one lamp of the at least one lamp apparatus is a lamp frame mounted inside one of the at least one translucent shell and having
two sides;
a front;
a rear;
at least one lamp bracket mounted on and protruding from the front of the lamp frame and the at least one lamp is mounted respectively in the at least one lamp bracket and highlighting the at least one translucent shell.

5. The ornamental lamp as claimed in claim 4, wherein
each of the at least one translucent shell further has
a bottom being translucent and flat to make the ornamental lamp stand;
a top being translucent and flat to make the adjacent translucent shell stand on;
two sides being translucent and being formed and communicating with the top, the bottom and the front surface and having
an inner surface; and
a rear edge;
the first connector is multiple lamp frame connectors formed in a longitudinal line in the inner surface of the sides near the rear edges; and a plug connected to the at least one lamp and to an external power source to provide electricity to illuminate the at least one lamp; and
the second connector is multiple mounting tabs formed on and protruding out from the sides of the lamp frame and corresponding to and mounted respectively in the lamp frame connectors inside a corresponding translucent shell.

6. The ornamental lamp as claimed in claim 1 further has accessories being mounted on the at least one translucent shells.

7. The ornamental lamp as claimed in claim 1, wherein the front surface and the sides of the at least one translucent shell have relief.

8. The ornamental lamp as claimed in claim 1, wherein the at least one translucent shell further has different colors and patterns.

9. The ornamental lamp as claimed in claim 1, wherein each one of the at least one translucent shell further has
a top being translucent and flat and having
a lower connector;
a bottom being translucent and flat so the translucent shell stand on any flat surface and having
an upper connector corresponding to, aligning with and connecting to the lower connector.

10. The ornamental lamp as claimed in claim 9, wherein
the top of each one of the at least one translucent shell further has a cutout formed in the top and communicating with the open rear; and
the bottom of each one of the at least one translucent shell further has a cutout formed in the bottom, communicating with the open rear and corresponding to and aligning with the cutout in the top.

11. The ornamental lamp as claimed in claim 4, wherein the lamp frame is a grid-like frame.

12. The ornamental lamp as claimed in claim 2, wherein
the top of each one of the at least one translucent shell further has a lower connector;
the bottom of each one of the at least one translucent shell further has an upper connector corresponding to, aligning with and connecting to the lower connector; and
the top of the base further has a lower connector corresponding to, aligning with and connecting to the upper connector of an adjacent translucent shell.

13. The ornamental lamp as claimed in claim 2, wherein
the bottom of each one of the at least one translucent shell further has a cutout being formed in the bottom and communicating with the open rear; and
the top of the base further has a through hole corresponding to and aligning with the cutout in the bottom of an adjacent translucent shell and the electric wires pass through the through hole and the cutout.

14. The ornamental lamp as claimed in claim 3, wherein the connector of each one of the at least one cover is four hooks mounted on and protruding from the inside surface of the cover respectively near the four corners and hooking onto the rear of a corresponding one of the at least one the lamp frame.

15. The ornamental lamp as claimed in claim 12, wherein
the lower connector of the base is at least one slot;
the lower connector of each one of the at least one translucent shell is at least one slot; and
the upper connector of each one of the at least one translucent shell is at least one blade.

16. The ornamental lamp as claimed in claim 12, wherein
the lower connector of the base is at least one blade;
the lower connector of each one of the at least one translucent shell is at least one blade; and
the upper connector of each one of the at least one translucent shell is at least one slot.

17. The ornamental lamp as claimed in claim 12, wherein
the lower connector of the base is at least one through hole;
the lower connector of each one of the at least one translucent shell is at least one through hole; and
the upper connector of each one of the at least one translucent shell is at least one protruding rod.

18. The ornamental lamp as claimed in claim 12, wherein
the lower connector of the base is at least one protruding rod;
the lower connector of each one of the at least one translucent shell is at least one protruding rod; and
the upper connector of each one of the at least one translucent shell is at least one through hole.

19. The ornamental lamp as claimed in claim 12, wherein
the lower connector of the base is at least one blade;
the lower connector of each one of the at least one translucent shell is at least one blade; and
the upper connector of each one of the at least one translucent shell is at least one through hole.

20. The ornamental lamp as claimed in claim 12, wherein
the lower connector of the base is at least one through hole;
the lower connector of each one of the at least one translucent shell is at least one through hole; and
the upper connector of each one of the at least one translucent shell is at least one blade.
